(19) United States
(12) Patent Application Publication
(10) Pub. No.: US 2025/0145486 A1
(43) Pub. Date: May 8, 2025

(54) GAS-LIQUID CONTACTOR SYSTEM

(71) Applicant: SkyNano LLC, Louisville, TN (US)

(72) Inventors: David L. WOOD, III, Knoxville, TN (US); James O'MALLEY, Knoxville, TN (US); Anna E. DOUGLAS, Knoxville, TN (US)

(73) Assignee: SkyNano LLC, Louisville, TN (US)

(21) Appl. No.: 18/501,346

(22) Filed: Nov. 3, 2023

(51) Int. Cl. C01D 15/08; B01D 53/62; B01D 53/78

(52) U.S. Cl. CPC C01D 15/08; B01D 53/62; B01D 53/78; B01D 2251/302; B01D 2251/602; B01D 2257/504

(57) ABSTRACT

The present disclosure describes a contactor device which may include a housing including a tank and a lid, wherein there is a seal between the tank and the lid, at least one liquid inlet, at least one gas inlet, a bed of a contact medium contained within the tank and positioned over a barrier having a plurality of through holes, at least one liquid outlet, at least one gas outlet, and a guide plate positioned to prevent the liquid from reaching the gas outlet. Methods of operating a contactor device are also described and may include methods of capturing and converting carbon dioxide to commercially useful materials.

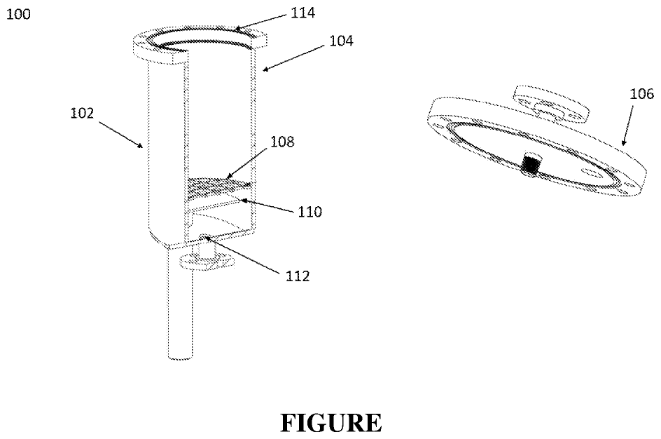

### GOVERNMENT INTEREST

This invention was made with government support under DE-FE0031913 awarded by the United States Department of Energy. The government has certain rights in the invention.

### BACKGROUND

The concentration of carbon dioxide in the atmosphere is now about 420 parts per million, which is the highest concentration in history. Because of the relationship between atmospheric CO₂ and global warming, technologies that capture, store, or convert CO₂ are desirable. However, known processes are not only costly from the perspective of thermodynamic and electrochemical inputs, but they tend to produce materials which have little, if any, commercial value. There is a need for processes that not only capture and store CO₂ from the atmosphere, but also produce materials with appreciable commercial value. For example, processes that capture and store CO₂ from the atmosphere by forming carbon allotropes, and the development of supporting subsystems and methods related to these processes, would be particularly desirable.

In realizing the goal of effective CO₂ capture and conversion, there is a need for subsystem which allows contact between a CO₂-containing gas stream and lithium oxide-containing medium to remove CO₂ from the gas stream and facilitate the production of profitable and/or useful end products such as carbon allotropes. Gas-liquid contactors are important pieces of equipment for facilitating heat and mass transfer between a gas phase and a liquid phase. Gas-liquid contactors can be used in separation processes, such as distillation or absorption, or as reactors for various reactions between gas and liquid components.

Several configurations for gas-liquid contactors exist, including trickle-bed systems, contactor towers, and others. There remains a need for designs which can function to effectively contact CO₂-containing gas streams with a liquid, particularly at high operating temperatures above about 600° C.

### SUMMARY

In some aspects, the techniques described herein relate to a contactor device, including: a furnace including a housing and having an insulation layer surrounding the furnace, the housing including a tank and a lid, wherein there is a seal between the tank and the lid, at least one liquid inlet, at least one gas inlet, a bed of a contact medium contained within the tank and positioned over a barrier having a plurality of through holes, at least one liquid outlet, and at least one gas outlet.

In some aspects, the techniques described herein relate to a contactor device, wherein the seal includes a flange.

In some aspects, the techniques described herein relate to a contactor device, wherein the seal is welded.

In some aspects, the techniques described herein relate to a contactor device, wherein the seal includes an ultra-high vacuum gasket.

In some aspects, the techniques described herein relate to a contactor device, further including a guide plate positioned to prevent the liquid from reaching the gas outlet.

In some aspects, the techniques described herein relate to a contactor device, wherein the at least one liquid inlet, the at least one gas inlet, the at least one liquid outlet, and the at least one gas outlet are each connected to the housing with a flange.

In some aspects, the techniques described herein relate to a contactor device, wherein the flanges connecting the least one liquid inlet and the at least one liquid outlet to the housing further include a gasket.

In some aspects, the techniques described herein relate to a contactor device, wherein the gasket includes graphite and an alloy.

In some aspects, the techniques described herein relate to a contactor device, wherein the at least one liquid inlet includes a sprayer.

In some aspects, the techniques described herein relate to a contactor device, wherein the contact medium includes a ceramic material.

In some aspects, the techniques described herein relate to a contactor device, wherein the contact medium includes Raschig rings, Pall rings, berl saddles, or combinations thereof.

In some aspects, the techniques described herein relate to a contactor device, wherein the tank has a height-to-width ratio of about 1:1 to about 25:1.

In some aspects, the techniques described herein relate to a contactor device, wherein the contactor device does not include a valve.

In some aspects, the techniques described herein relate to a contactor device, wherein the at least one liquid inlet and the at least one gas inlet are connected to an upper portion of the housing, and wherein the at least one liquid outlet and the at least one gas outlet are connected to a bottom portion of the housing.

In some aspects, the techniques described herein relate to a contactor device, further including a system for measuring the concentration of carbon dioxide at the at least one gas inlet, the at least one gas outlet, or a combination thereof.

In some aspects, the techniques described herein relate to a method 1, including: directing a liquid through the at least one liquid inlet and directing a gas through the at least one gas inlet, contacting the liquid with the gas, and collecting the liquid from the at least one liquid outlet and collecting the gas from the at least one gas outlet.

In some aspects, the techniques described herein relate to a method, wherein the liquid includes a molten salt.

In some aspects, the techniques described herein relate to a method, wherein the liquid includes lithium.

In some aspects, the techniques described herein relate to a method, wherein the liquid includes lithium carbonate and lithium oxide.

In some aspects, the techniques described herein relate to a method, wherein the liquid includes at least about 0.1 molal lithium oxide in lithium carbonate.

In some aspects, the techniques described herein relate to a method, wherein the liquid is at a temperature of about 650° C. to about 850° C. prior to being directed through the at least one liquid inlet.

In some aspects, the techniques described herein relate to a method, wherein the gas is at a temperature of about 25° C. to about 650° C. prior to being directed through the at least one gas inlet.

In some aspects, the techniques described herein relate to a method, wherein the gas includes about 1 vol. % to about 99 vol. % carbon dioxide prior to contacting the liquid with the gas.

In some aspects, the techniques described herein relate to a method, wherein the gas includes carbon dioxide, and wherein contacting the liquid with the gas initiates a chemical reaction.

In some aspects, the techniques described herein relate to a method, wherein the gas includes carbon dioxide, and wherein contacting the liquid with the gas includes removing carbon dioxide from the gas.

In some aspects, the techniques described herein relate to a method, wherein the contactor device is operated continuously.

In some aspects, the techniques described herein relate to a method, further including measuring the concentration of carbon dioxide at the at least one gas inlet, the at least one gas outlet, or a combination thereof.

In some aspects, the techniques described herein relate to a method, further including measuring the reaction of carbon dioxide with lithium oxide to form lithium carbonate.

### BRIEF DESCRIPTION OF THE DRAWING

Aspects, features, benefits, and advantages of the embodiments described herein will be apparent with regard to the following description, appended claims, and accompanying drawings where:

The FIGURE an illustrative diagram of the components of the contactor device, according to embodiments of the present disclosure.

### DETAILED DESCRIPTION

The present disclosure describes a contactor system for contacting gases and liquids, such as gas streams which contain carbon dioxide and liquids which contain molten carbonate salts and corresponding dissolved oxides, without wishing to be bound by theory.

Before describing the embodiments in detail, the following definitions are used throughout the present disclosure.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55% and also includes exactly 50%.

In some embodiments, there is provided a contactor device which includes: a furnace including a housing and an insulation layer surrounding the furnace; the housing including a tank and a lid, wherein there is a seal between the tank and the lid; at least one liquid inlet; at least one gas inlet; a bed of a contact medium contained within the tank and positioned over a barrier having a plurality of through holes; at least one liquid outlet; and at least one gas outlet. In some embodiments, the contactor device further includes a guide plate positioned to prevent the liquid from reaching the gas outlet.

The FIGURE an illustrative diagram of the components of the contactor device, according to embodiments of the present disclosure. As shown in the FIGURE, the contactor device 100 may include a housing 102, a tank 104, a lid 106, a barrier 108, a guide plate 110, at least one liquid outlet 112, and a seal 114.

In some embodiments, the housing is formed from metal, ceramic, or combinations thereof. Suitable materials for the housing may include but are not limited to steel and other alloys, silicon carbide, graphite, the like, and combinations thereof. In some embodiments, alloys which include nickel, chromium, cobalt, molybdenum, niobium, tantalum, tungsten, rhenium, titanium, vanadium, zirconium, hafnium, ruthenium, osmium, iridium, and combinations thereof may be suitable for the components of the contactor device disclosed herein. Without wishing to be bound by theory, materials for the present contactor device should be suitable for high temperatures and resistant to corrosion. In some embodiments, the materials of the contactor device are suitable for operation at a temperature of at least about 600° C., such as at least about 650° C., at least about 700° C., at least about 750° C., at least about 800° C., at least about 850° C., and so forth.

In some embodiments, the housing includes an insulation layer. In some embodiments, the housing may be formed from a first material and the insulation layer may be formed from the same or a different material. In some embodiments the guide plate is formed from the same material as the housing, and in some embodiments, the guide plate is formed from a different material.

In some embodiments, the seal between the tank and the lid is a hermetic seal. In some embodiments, the seal between the tank and the lid includes a flange. The size and diameters of the flanges are not particularly limited and may be selected by a person of ordinary skill in the art, with consideration towards the number of flange bolts permitted by the overall size of the contactor device and the resulting flange bolt stress induced by operation of the contactor device. In some embodiments, the seal between the tank and the lid is welded, such that the seal does not include a flange.

In some embodiments, the seal includes plastically deformable gasket or o-ring, which may be formed from a metal, such as but not limited to copper. In some embodiments, the seal includes an ultra-high vacuum gasket. In some embodiments, the seal includes a ConFlat gasket. The seal may be designed such that there is a knife-edge seal, and in some embodiments, the seal includes a single-use metallic ring gasket. The gasket may be formed from materials such as graphite, mica, or metals (including but not limited to titanium) and other materials which have an appropriate hardness and suitability for high temperature operation.

In some embodiments, the at least one liquid inlet, the at least one gas inlet, the at least one liquid outlet, and the at least one gas outlet are each connected to the housing with a flange.

In some embodiments, the flanges of the contactor device further comprise a gasket. As with the other components of the contactor device, the gaskets of the present disclosure are suitable for operation at a temperature of at least about 600° C. and in corrosive conditions. Gasket materials should be non-chemically reactive with the gases and liquids to be used in the contactor device and should be oxidatively stable to outside air, without wishing to be bound by theory.

In some embodiments, the gasket includes graphite, an alloy, or combinations thereof. In some embodiments, the gasket includes a non-chemically reactive material on the inside of the gasket, which may be in contact with the gases and liquids passing through the contactor device, and an oxidatively stable material on the outside of the gasket, such that the gasket is protected by oxidative degradation from exposure to outside air. In some embodiments, the gasket includes a nickel-containing alloy as the oxidatively stable material and graphite as the non-chemically reactive materials. In some embodiments, the gasket is designed such that the lid flange bolt stress is below the creep stress limit.

In some embodiments, the at least one liquid inlet is designed to introduce a liquid to the contactor system, and may include a liquid distributor, such as a sprayer, a baffle, a nozzle, or other apparatus for distributing liquid. In some embodiments, the at least one liquid inlet includes a sprayer. In some embodiments, the sprayer is in the form of a shower head design which spreads the liquid evenly over the contact medium.

In some embodiments, the contact medium includes a ceramic material. For example, the contact medium may include Raschig rings, Pall rings, berl saddles, or combinations thereof.

In some embodiments, the tank has a height-to-width ratio of about 1:1 to about 25:1. For example, the tank may have a height to width ratio of about 1:1, about 2:1, about 3:1, about 4:1, about 5:1, about 6:1, about 7:1, about 8:1, about 9:1, about 10:1, about 11:1, about 12:1, about 13:1, about 14:1, about 15:1, about 16:1, about 17:1, about 18:1, about 19:1, about 20:1, about 21:1, about 22:1, about 23:1, about 24:1, about 25:1, or any value contained within a range formed by any of the preceding values.

In some embodiments, the contactor device does not include a valve; that is, in some embodiments, the contactor device is valveless. The means and apparatuses for controlling the flow of a fluid without a valve are not particularly limited and may be selected by those skilled in the art.

In some embodiments, the at least one liquid inlet and the at least one gas inlet are connected to an upper portion of the housing, and wherein the at least one liquid outlet and the at least one gas outlet are connected to a bottom portion of the housing.

In some embodiments, the contactor device further includes a system for measuring the concentration of carbon dioxide at the at least one gas inlet, the at least one gas outlet, or a combination thereof. Any such measurement system known to those skilled in the art may be employed in the contactor device of the present disclosure.

In some embodiments, there is provided a method of operating the contactor device of the present disclosure, including: directing a liquid through the at least one liquid inlet and directing a gas through the at least one gas inlet, contacting the liquid with the gas, and collecting the liquid from the at least one liquid outlet and collecting the gas from the at least one gas outlet.

In some embodiments, the liquid includes a molten salt. In some embodiments, the liquid includes a carbonate and an oxide. In some embodiments, the liquid includes lithium carbonate, lithium oxide, calcium carbonate, calcium oxide, or combinations thereof. In some embodiments, the liquid includes an oxide in a concentration of at least about 0.1 molal (m), such as about 0.1 m, about 0.1 m, about 0.3 m, about 0.4 m, about 0.5 m, about 0.6 m, about 0.7 m, or any value contained within a range formed by any two of the preceding values. In some embodiments, the liquid includes lithium carbonate and lithium oxide. In such an embodiment, the liquid may include lithium carbonate and lithium oxide in an amount of at least about 0.1 molal lithium oxide in lithium carbonate.

In some embodiments, the liquid is at a temperature of about 650° C. to about 850° C. prior to being directed through the at least one liquid inlet. For example, in some embodiments, the liquid is at a temperature of about 650° C., about 675° C., about 700° C., about 725° C., about 750° C., about 775° C., about 800° C., about 825° C., about 850° C., or any value contained within a range formed by any of the preceding values.

In some embodiments, the gas is at a temperature of about 25° C. to about 650° C. prior to being directed through the at least one gas inlet. For example, in some embodiments, the gas is at a temperature of about 25° C., about 50° C., about 100° C., about 150° C., about 200° C., about 250° C., about 300° C., about 350° C., about 400° C., about 450° C., about 500° C., about 550° C., about 575° C., about 600° C., about 625° C., about 650° C., or any value contained within a range formed by any of the preceding values.

In some embodiments, the gas includes about 1 vol. % to about 99 vol. % carbon dioxide prior to contacting the liquid with the gas. For example, in some embodiments, the gas includes carbon dioxide in an amount of about 1 vol. %, about 5 vol. %, about 10 vol. %, about 15 vol. %, about 20 vol. %, about 25 vol. %, about 30 vol. %, about 35 vol. %, about 40 vol. %, about 45 vol. %, about 50 vol. %, about 55 vol. %, about 60 vol. %, about 65 vol. %, about 70 vol. %, about 75 vol. %, about 80 vol. %, about 85 vol. %, about 90 vol. %, about 95 vol. %, about 99 vol. %, or any value contained within a range formed by any of the preceding values.

In some embodiments, contacting the liquid with the gas initiates a thermochemical reaction. In some embodiments, the liquid includes a molten carbonate and a dissolved oxide, and the gas includes carbon dioxide. For example, the liquid may include molten lithium carbonate, calcium carbonate, or a combination thereof, and further includes dissolved lithium oxide. The gas may include carbon dioxide along with other gaseous species including oxygen, nitrogen, argon, the like, and combinations thereof. In such an embodiment, the chemical reaction between the carbon dioxide and the dissolved lithium oxide forms additional lithium carbonate, which is in a liquid form, and thus reduces the amount of carbon dioxide in the gas stream. In some embodiments, the thermochemical reaction described herein may reduce the mass flow rate of carbon dioxide in the gas, and the resulting gas stream may be collected through the at least one gas outlet.

In some embodiments, contacting the liquid with the gas comprises removing carbon dioxide from the gas. Contacting the liquid with the gas may, in some embodiments, remove substantially all of the carbon dioxide in the gas, or contacting the liquid with the gas may remove a portion of the carbon dioxide in the gas. In some embodiments, contacting liquid with the gas removes about 10% to about 99% of the carbon dioxide from the gas, such as about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 99%, or any value contained within a range formed by any of the preceding values.

In some embodiments, the method includes operating the contactor device continuously. Operating the contactor device continuously may include continually directing the liquid and the gas through the at least one liquid inlet and the at least one gas inlet, contacting the liquid with the gas, and directing the liquid and the gas through the at least one liquid outlet and the at least one gas outlet. In some embodiments, the liquid and the gas which are directed through the at least one liquid outlet and the at least one gas outlet have a different chemical composition than the original liquid and gas.

In some embodiments, the method further includes measuring the concentration of carbon dioxide at the at least one gas inlet, the at least one gas outlet, or a combination thereof. Any method of measuring the concentration of carbon dioxide known to those skilled in the art may be used in the presently disclosed method.

In some embodiments, the method further includes measuring the reaction of carbon dioxide with lithium oxide to form lithium carbonate. Any method of measuring and monitoring this reaction available to those skilled in the art is within the scope of the present disclosure.

### EXAMPLES

### Example 1

A representative contactor device of the present disclosure is shown in the FIGURE. The FIGURE an illustrative diagram of the components of the contactor device, according to embodiments of the present disclosure. As shown in the FIGURE, the contactor device 100 may include a housing 102, a tank 104, a lid 106, a barrier 108, a guide plate 110, at least one liquid outlet 112, and a seal 114.

The contactor device may be operated as described herein, using a gas stream which includes carbon dioxide and a liquid which includes lithium carbonate and lithium oxide. The gas stream may include about 1 vol. % to about 99 vol. % carbon dioxide at a stoichiometric ratio of about 1:20 moles of lithium oxide to carbon dioxide prior to performing the method of the present disclosure. The liquid includes about 0.4 molal to about 0.6 molal lithium oxide in lithium carbonate, though other concentrations of lithium oxide may also be suitable, such as at least about 0.1 molal lithium oxide.

This disclosure is not limited to the particular systems, devices and methods described, as these may vary. The terminology used in the description is for the purpose of describing the particular versions or embodiments only and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the FIGURES, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 compounds refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed is:

1. A contactor device, comprising:
a furnace comprising a housing and having an insulation layer surrounding the furnace,
the housing comprising a tank and a lid, wherein there is a seal between the tank and the lid,
at least one liquid inlet,
at least one gas inlet,
a bed of a contact medium contained within the tank and positioned over a barrier having a plurality of through holes,
at least one liquid outlet, and
at least one gas outlet.

2. The contactor device of claim 1, wherein the seal comprises a flange.

3. The contactor device of claim 1, wherein the seal is welded.

4. The contactor device of claim 1, wherein the seal comprises an ultra-high vacuum gasket.

5. The contactor device of claim 1, further comprising a guide plate positioned to prevent the liquid from reaching the gas outlet.

6. The contactor device of claim 1, wherein the at least one liquid inlet, the at least one gas inlet, the at least one liquid outlet, and the at least one gas outlet are each connected to the housing with a flange.

7. The contactor device of claim 6, wherein the flanges connecting the least one liquid inlet and the at least one liquid outlet to the housing further comprise a gasket.

8. The contactor device of claim 7, wherein the gasket comprises graphite and an alloy.

9. The contactor device of claim 1, wherein the at least one liquid inlet comprises a sprayer.

10. The contactor device of claim 1, wherein the contact medium comprises a ceramic material.

11. The contactor device of claim 1, wherein the contact medium comprises Raschig rings, Pall rings, berl saddles, or combinations thereof.

12. The contactor device of claim 1, wherein the tank has a height-to-width ratio of about 1:1 to about 25:1.

13. The contactor device of claim 1, wherein the contactor device does not include a valve.

14. The contactor device of claim 1, wherein the at least one liquid inlet and the at least one gas inlet are connected to an upper portion of the housing, and wherein the at least one liquid outlet and the at least one gas outlet are connected to a bottom portion of the housing.

15. The contactor device of claim 1, further comprising a system for measuring the concentration of carbon dioxide at the at least one gas inlet, the at least one gas outlet, or a combination thereof.

16. A method of operating the contactor device of claim 1, comprising:
directing a liquid through the at least one liquid inlet and directing a gas through the at least one gas inlet,
contacting the liquid with the gas, and
collecting the liquid from the at least one liquid outlet and collecting the gas from the at least one gas outlet.

17. The method of claim 16, wherein the liquid comprises a molten salt.

18. The method of claim 16, wherein the liquid comprises lithium.

19. The method of claim 16, wherein the liquid comprises lithium carbonate and lithium oxide.

20. The method of claim 16, wherein the liquid comprises at least about 0.1 molal lithium oxide in lithium carbonate.

21. The method of claim 16, wherein the liquid is at a temperature of about 650° C. to about 850° C. prior to being directed through the at least one liquid inlet.

22. The method of claim 16, wherein the gas is at a temperature of about 25° C. to about 650° C. prior to being directed through the at least one gas inlet.

23. The method of claim 16, wherein the gas comprises about 1 vol. % to about 99 vol. % carbon dioxide prior to contacting the liquid with the gas.

24. The method of claim 16, wherein the gas comprises carbon dioxide, and wherein contacting the liquid with the gas initiates a chemical reaction.

25. The method of claim 16, wherein the gas comprises carbon dioxide, and wherein contacting the liquid with the gas comprises removing carbon dioxide from the gas.

26. The method of claim 16, wherein the contactor device is operated continuously.

27. The method of claim 16, further comprising measuring the concentration of carbon dioxide at the at least one gas inlet, the at least one gas outlet, or a combination thereof.

28. The method of claim 16, further comprising measuring the reaction of carbon dioxide with lithium oxide to form lithium carbonate.
